(19) United States
(12) Patent Application Publication
(10) Pub. No.: US 2025/0049211 A1
(43) Pub. Date: Feb. 13, 2025

(54) FRAME SYSTEM FOR INSTALLATION IN A PIECE OF WORK FURNITURE AND WORK FURNITURE

(71) Applicant: BLANCO GMBH + CO KG, Oberderdingen (DE)

(72) Inventors: Tobias TACK, Oberderdingen (DE); Mirko HAMANN, Güglingen (DE); Thomas FUNKE, Eppingen (DE)

(73) Assignee: BLANCO GMBH + CO KG, Oberderdingen (DE)

(21) Appl. No.: 18/797,803

(22) Filed: Aug. 8, 2024

(30) Foreign Application Priority Data
Aug. 9, 2023 (DE) 10 2023 207 640.3

(51) Int. Cl. A47B 77/06; A47B 9/00; A47B 13/02

(52) U.S. Cl. CPC A47B 77/06; A47B 9/00; A47B 13/02

(57) ABSTRACT

The invention relates to a frame system for installation in a piece of work furniture, in particular a piece of sanitary work furniture, comprising a first frame module and a second frame module, wherein the first and the second frame module each have at least one insertion opening for inserting at least one pre-installed functional component for a user, wherein the respective insertion opening has a quadrangular cross-section, and wherein the first and second frame modules can be fixed to each other by means of a tool-free connection.

The invention relates to a frame system for installation in a piece of work furniture.

The invention also relates to work furniture with a frame system.

Although generally applicable to any piece of work furniture, the present invention is explained in relation to a piece of sanitary furniture in the form of a kitchen base unit.

Kitchen base units are usually used to house different equipment, for example a waste separation system for a sink user and possibly a water treatment unit or similar. As individual constraints, such as the width, depth and height of the kitchen base unit, which can also be changed by a user at short notice, often have to be taken into account, it has become common practice to set the individual equipment directly on the base unit or its movable front, for example on a door. The individual pieces of equipment have a wide variety of dimensions and are installed directly on site by an installer at a position in the base cabinet that suits them, which requires a great deal of time and complexity.

In order to partially separate at least the piping of the sink from the other equipment to be arranged, as known from DE 103 17 071 A1, a rectangular installation frame is to be provided in the base unit for this purpose, which is fixed in the base unit, comprising interconnected frame struts forming an essentially rectangular frame, auxiliary struts attached to the frame and lying in the frame plane, corner valves fastened to an auxiliary strut with pressure-resistant connecting hoses for an over-sink outlet fitting and for connection to water inlet pipes on the wall side, wherein the complete installation subframe can be inserted in the chamber of the base unit which is essentially open to the wall behind it and can be attached to the floor and/or the side walls of the base unit, and a cover which covers the installation frame at the front and is detachably fastened to the installation frame.

The disadvantage of this is the complex design and the lack of flexibility when installing larger and/or heavier components.

To solve this problem, DE 10 2021 203 803 A1 describes a two-part frame module that can be subdivided by means of separating elements within the frame module for functional components.

However, the disadvantage of this is that although it is possible to pre-assemble the frame module with functional components such as drawers, a water treatment unit or similar, it is considerably more difficult for an installer to deliver the frame module with the pre-installed functional components on site due to the heavy weight involved. Another disadvantage is that it is not possible to arrange the functional components in different ways, for example with the drawer on the left and the water treatment unit on the right, depending on the customer's wishes, without time-consuming disassembly and reassembly. The width of the frame module cannot be changed either, which makes it impossible to adapt it to a base unit with different dimensions.

One object of the present invention is therefore to provide a frame system and work furniture with a frame system which can be adapted more flexibly to different dimensions of base units and at the same time enable improved manageability on site at the customer's premises.

A further object of the present invention is to provide an alternative frame system and a piece of alternative work furniture with a frame system.

In an embodiment, the present invention meets the above-mentioned objects with a frame system for installation in a piece of work furniture, in particular a piece of sanitary work furniture, comprising a first frame module and a second frame module, wherein the first and the second frame module each have at least one insertion opening for inserting at least one pre-installed functional component for a user, wherein the respective insertion opening has a quadrangular cross-section, and wherein the first and second frame modules can be fixed to one another by means of a tool-free connection.

In an embodiment, the present invention meets the aforementioned objects with a piece of work furniture having a frame system according to any one of claims 1-18.

The term “sanitary” is to be understood in the broadest sense and refers, in particular in the description, preferably in the claims, among others, to any objects, arrangements, devices, equipment and the like in connection with bathrooms, kitchens, heating systems and the like.

The formulation “installation in a piece of work furniture” is to be understood in the broadest sense and refers, in particular in the claims, preferably in the description, to any arrangement in, on, between or under one or more pieces of work furniture. In particular, the formulation refers not only to the installation of the frame system in a piece of work furniture, but also to the arrangement on a floor under a worktop and between two separate pieces of work furniture.

The formulation “tool-free connection” is to be understood in the broadest sense and refers, in particular in the claims, preferably in the description, to any form-fit, material-fit and/or force-fit connection which can be produced manually and/or by means of objects not defined in terms of a tool and which can also be released again if necessary. A tool-free connection can, for example, be a snap-in connection in which a tab engages in a corresponding opening when the corresponding component with the tab is manually pushed into a component with the opening. The snap-in connection can then be released again either manually or using an object, such as a pencil, by pressing in or lifting the tab. The pencil is not a tool in the sense of the present invention.

One of the advantages of this is that it is easier to install on site, especially if the functional components are pre-assembled by an installer. This means that functional components can be preassembled in each of the two frame modules and the two frame modules are then easier to fit together because they are lighter in weight and are only fixed together in a kitchen base unit or similar, for example. The frame modules can also be adapted more flexibly to different dimensions of base units. For example, one of the frame modules can always have the same dimensions and the other of the two frame modules can have different dimensions in order to be able to take different dimensions of base units into account when arranging the two frame modules. As the first frame module always has the same dimensions, it can be manufactured cost-effectively, which reduces the overall cost of the frame system.

Further features, advantages and further embodiments of the invention are described below or will become apparent thereby.

According to a preferred embodiment of the invention, a third frame module can be fixed to one side of each of the first and second frame modules, with the sides of the first and second frame modules forming a common plane. One of the advantages of this is that, on the one hand, the overall stability of the frame modules is increased and, on the other hand, the flexibility with regard to the arrangement of pre-installed functional components in particular is also increased.

According to a further preferred embodiment of the invention, the third frame module can be fixed to the first and/or second frame module, in particular to both frame modules, without tools. The advantage of this is that the third frame module can be fixed quickly and easily.

According to a further preferred embodiment of the invention, the first frame module and the second frame module have a different cross-section with respect to the respective insertion opening. The advantage of this is greater flexibility with regard to the arrangement of pre-installed functional components in particular.

According to a further preferred embodiment of the invention, the first and second frame modules are designed in such a way that they can be arranged next to each other in any desired arrangement along a predeterminable direction. This also increases flexibility and reduces costs at the same time. For example, it is possible for the first frame module to be arranged on both the left and the right side of the second frame module in front view. For example, the first and/or second frame module can be designed in such a way that they can be arranged symmetrically, for example when rotated by 180 degrees about a vertical axis, on the other side of the respective other module.

According to a further preferred embodiment of the invention, a fourth frame module is arranged as a plinth module, wherein the base module can be fixed to one side of each of the first and second frame modules, wherein the sides of the first and second frame modules form a common plane, in particular wherein the base module can be arranged on the opposite side of the third frame module on the first and second frame modules. The advantage of a plinth module is that no plinth has to be arranged on the work furniture, but the first, second and/or third frame module can also be arranged free-standing underneath a worktop or the like by means of the base module.

According to a further preferred embodiment of the invention, the plinth module has a height adjustment device for height and/or level adjustment and/or a distance adjustment device for adjusting a distance to a surrounding element, in particular a wall. The advantage of this is that the flexibility in adapting the frame system to local conditions such as unevenness in the floor space or a wall can be increased, as these can be compensated for and a reliable arrangement is still possible.

According to a further preferred embodiment of the invention, the tool-free connection is provided in the form of a plug-in connection and/or in the form of a particularly detachable clip and/or snap-in connection. The advantage of this is the simple and cost-effective provision of a tool-free, in particular detachable, connection.

According to a further preferred embodiment of the invention, at least one cover strip can be arranged on at least one of the frame modules. The advantage of this is that it is easier to adapt to different types of work furniture while maintaining a high level of visual appeal.

According to a further preferred embodiment of the invention, the at least one cover strip can be detachably or non-detachably connected to the at least one frame module, in particular by means of an adhesive connection. The advantage of a detachable connection is that the frame system can be dismantled if necessary for maintenance. The advantage of a non-detachable connection is that it provides a particularly simple and cost-effective connection.

According to a further preferred embodiment of the invention, one or more fixing elements are arranged for fixing the frame modules to one another and/or for fixing at least one cover strip to at least one of the frame modules. The advantage of this is that the reliability of fixing the frame modules to each other can be improved.

According to a further preferred embodiment of the invention, the third frame module has a U-shaped cross-section, comprising a base and two lateral legs, wherein the third frame module can be fixed with its base to the first and second frame modules. The advantage of this is that a functional component can be easily arranged in the third frame module.

According to a further preferred embodiment of the invention, the third frame module has a particularly rectangular recess on the two lateral legs. The advantage of this is, on the one hand, easier handling of the third frame module and, on the other hand, functional components can be easily installed in the recesses.

According to a further preferred embodiment of the invention, at least one drawer element and/or a waste separation element and/or a water treatment unit can be arranged in one or more of the frame modules. The advantage of this is the flexible adaptation of the arrangement of frame modules with functional components to different customer specifications.

According to a further preferred embodiment of the invention, the plinth module can be connected to the first and second frame modules by means of a detachable connection, in particular a screw and/or snap-in connection, and/or a non-detachable connection, in particular an adhesive connection. The advantage of this is simple assembly and disassembly in the event of maintenance.

According to a further preferred embodiment of the invention, the third frame module has an edge, in particular an upstand, which is oriented perpendicular to the common plane, in particular wherein this is arranged opposite to a rebate of the first and/or second frame module in the region of the abutment of the third frame module against the first and second frame module. The advantage of this is that it enables a reliable arrangement of functional components in the third frame module.

According to a further preferred embodiment of the invention, the plug-in connection can be provided in the form of a U-shaped rebate on one of the two frame modules, first and second frame module, which can be slid over an edge of the other of the two frame modules. The advantage of this is that the frame modules are easy to assemble and at the same time reliably fixed to each other.

According to a further preferred embodiment of the invention, the third frame module has a U-shaped rebate which can be slid over an edge of the first and/or second frame module. The advantage of this is simple assembly while at the same time reliably securing the third frame module to the first and second frame modules.

According to a further preferred embodiment of the invention, a balancing module and/or a storage module can be fixed to the work furniture and/or the frame system. The advantage of this is the increased flexibility of adaptability to different dimensions of work furniture or functional components.

Further important characteristics and embodiments of the invention result from the sub-claims, from the drawings and from the associated description of the figures with reference to the drawings.

It is understood that the above-mentioned characteristics, and characteristics yet to be explained below, may be used not only in the respectively indicated combination, but also in other combinations or alone, without departing from the scope of the present invention.

Preferred designs and embodiments of this invention are shown in the accompanying drawings and are explained in more detail in the following description, wherein identical reference numbers refer to identical or similar or functionally identical components or elements.

In the form of a diagram,

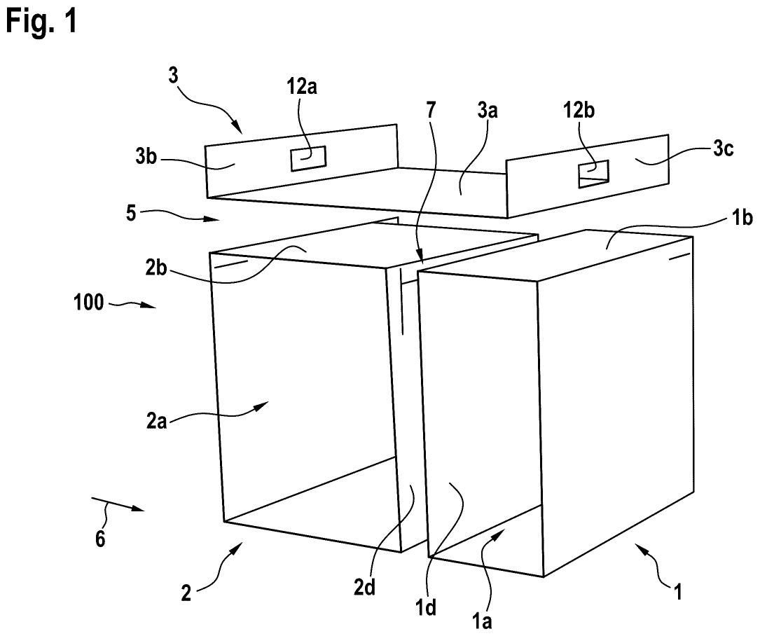

FIG. 1 shows a frame system according to an embodiment of the present invention;

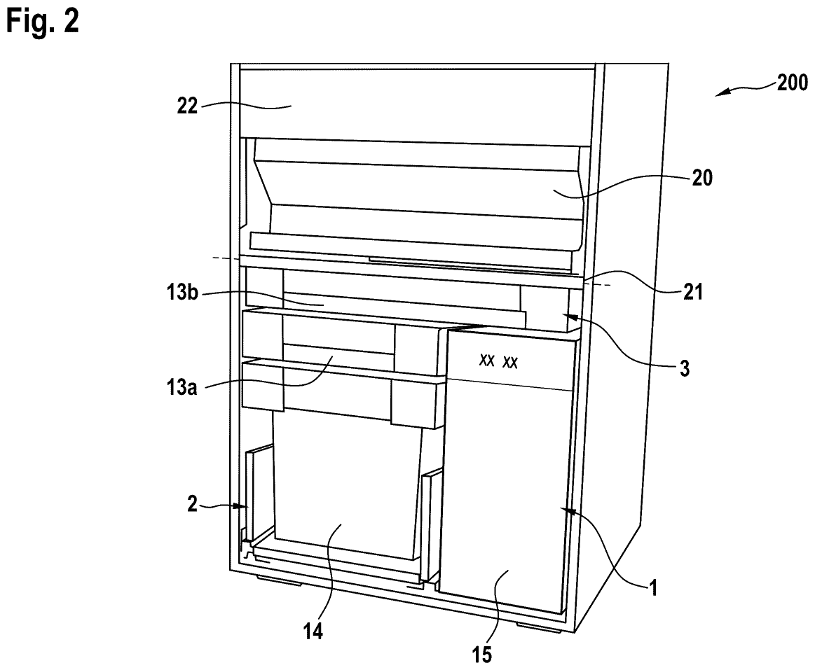

FIG. 2 shows a piece of work furniture according to an embodiment of the present invention;

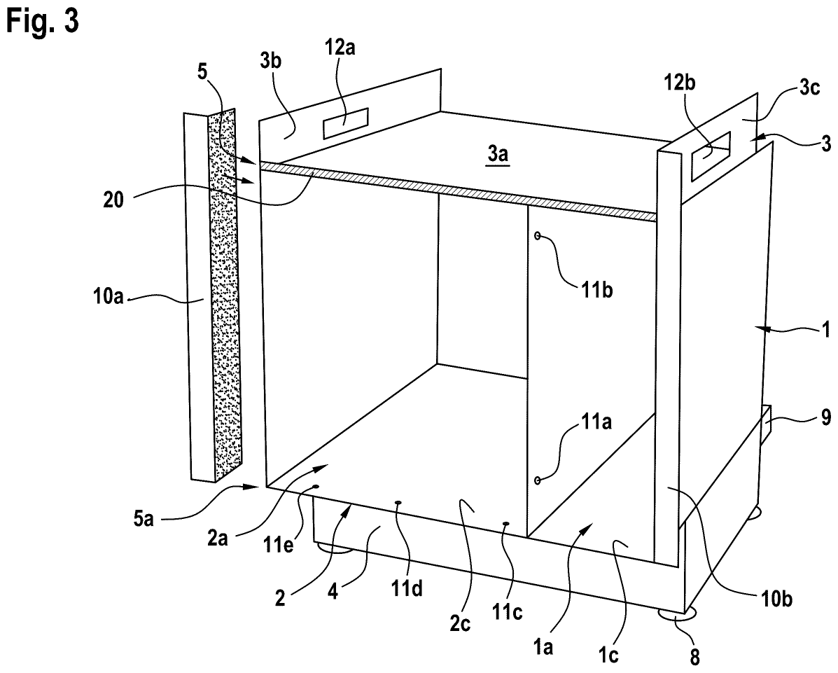

FIG. 3 shows a frame system according to an embodiment of the present invention;

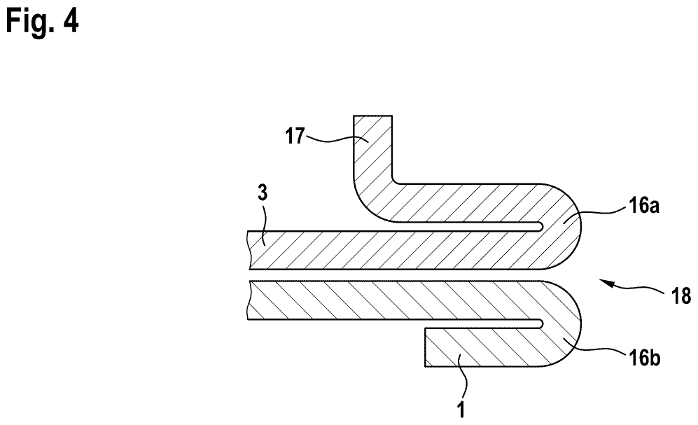

FIG. 4 shows a cross-section in the region of the abutment of a third frame module on a first frame module of a frame system according to an embodiment of the present invention; and

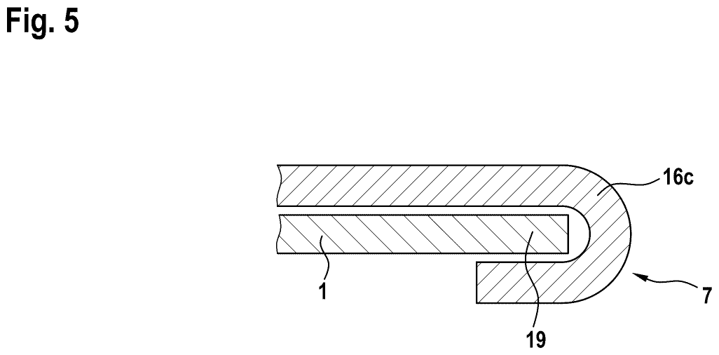

FIG. 5 shows a cross-section in the region of the abutment of a third frame module on a first frame module of a frame system according to an embodiment of the present invention.

FIG. 1 shows a frame system according to an embodiment of the present invention.

FIG. 1 shows a frame system 100 comprising two frame modules 1, 2 of a rectangular cross-section. The frame modules 1, 2 each have an insertion opening 1a, 2a. On the side of the frame module 1, 2 facing away from the insertion opening 1a, 2a there is also an opening, here of the same size and not provided with a reference sign. The two frame modules 1, 2 can be fixed together by means of a tool-free connection, in this case a plug-in connection 7. The left side surface 1d of the first frame module 1 can be fixed to the right side surface 2d of the second frame module 2. On the upper side 1b, 2b of the two frame modules 1, 2, which form a common plane 5, a third frame module 3 is arranged, which has a U-shape in cross-section with a base 3a, which rests against the upper sides 1b, 2b of the frame modules 1, 2 and is detachably connected to the frame modules 1, 2 and with two legs 3b, 3c, which project vertically upwards out of the plane 5. The legs 3b, 3c each have a lateral recess 12a, 12b, which is rectangular in shape. The third frame module 3 is designed in such a way that it extends along direction 6 across the entire width of the two frame modules 1, 2. The depth of the third frame module 3 is less than the depth of the two frame modules 1, 2.

FIG. 2 shows a piece of work furniture according to an embodiment of the present invention.

FIG. 2 shows a piece of work furniture 200 that is essentially box-shaped. A first frame module 1 is arranged on the right-hand side in the lower area of the piece of work furniture 200 and a second frame module 2 is arranged to the left of it. Both frame modules 1, 2 are arranged on a base of the work furniture 200 and may be fixed to it. The two frame modules 1, 2 are also fixed together without tools. A water treatment unit 15 is arranged in the first frame module 1, a pull-out waste bin 14 is arranged in the lower area of the second frame module 2 and a drawer element 13a is arranged above it. A third frame module 3 is arranged above the two frame modules 1, 2, which has a further drawer element 13b that extends across the entire width of the work furniture 200.

Due to the height of the work furniture 200, a panel 21 is now arranged on the work furniture 200 above the third frame module 3, which is detachably attached to the other two frame modules 1, 2. Above the panel 21, an organiser shelf 20 is arranged directly on the work equipment 200, which is located below a cross-member 22 of the work equipment 200. In this way, gaps between the modules can be covered or covered over, so that a high-quality overall visual appearance is maintained.

FIG. 3 shows a frame system according to an embodiment of the present invention.

FIG. 3 essentially shows a frame system 100 as shown in FIG. 1. In contrast to the frame system 100 shown in FIG. 1, a fourth frame module 4 in the form of a plinth module is now shown in the frame system 100 shown in FIG. 3. Here, the two frame modules 1, 2 are connected to the top of the plinth module 4 by their respective undersides 1c, 2c, which form a common plane 5a, in particular detachably by means of screws 11c, 11d, 11e. The two frame modules 1, 2 are detachably fixed to each other by means of additional fixing elements, here in the form of screws 11a, 11b. Furthermore, L-shaped cover strips 10a, 10b are arranged on the right-hand side surface 2d and on the left-hand side surface 1d of the first and second frame modules 1, 2 and on the outer surfaces of the third frame module 3 corresponding to the side surfaces 1d, 2d by means of an adhesive connection. These are used to compensate for or cover gaps between the frame module 1, 2 and a piece of work equipment 200. The plinth module 4 also has height-adjustable feet 8 and depth-adjustable spacers 9 at the rear.

The modular structure of the frame system 100 shown in the figures comprises an embodiment with a frame system with a plinth module 4, a first and second frame module 1, 2 as a common base module, a panel module 21, a drawer module 3 as a third frame module and an organiser module 20. Modules 4, 1, 2, 3, 21, 20 are stacked and connected vertically. The plinth module 4 is not required for installation, for example in a kitchen base unit. The panel module 21 and the drawer module 3 are designed in such a way that they can be arranged accordingly depending on the planning requirements or that the drawer module 3 is at least partially installed under the panel module 21. The organiser module 20 forms the top end. The height of the panel module 21 and the drawer module 3 can be designed in such a way that the combination of the two modules 3, 21 or the omission of one of the modules 3, 21, in combination with the movement of the organiser module 20 in a vertical direction, can provide the greatest possible accuracy of fit with regard to the variance in the body heights of base units of work furniture 200. The modular arrangement shown here in the horizontal direction is designed for the 60 cm wide kitchen base unit and can be adapted in the horizontal extension for both narrower and wider kitchen base units in accordance with the present invention.

The base module is divided into at least two sub-modules—first and second frame module 1, 2—depending on the width of the cabinet. The division can be made at least in a vertical direction. The base module 1, 2 or the overlying modules 3, 20, 21 can be symmetrical or asymmetrical in the horizontal direction. The frame modules 1, 2 are designed in such a way that they can each represent the right and left variants of the frame module 1, 2. To do this, the respective module 1, 2 is rotated by 180 degrees around a vertical axis and then connected to each other. The connection of modules 1, 2, which can be detachable or non-detachable, can be made during production or by means of special sheet metal connections during assembly at the customer's premises. Screw connections, press-fit elements, etc. can be used as connecting elements for the modules.

One of the two frame modules 1, 2 can, for example, comprise a water treatment unit 15. In this case, the water treatment unit 15 can be installed directly in the respective frame module 1, 2 and not just inserted into the frame module 1, 2. Thus, the outer shell of the respective frame module 1, 2 also represents the outer shell of the water treatment unit 15. The water treatment unit 15 can be mounted on a carrier unit (not shown) and then inserted into the respective frame module 1, 2 during assembly. Cables and connecting lines are routed through or connected to a rear and/or front panel of the water treatment module 15.

The modules placed on the two frame modules 1, 2 can have a shallower depth in order to avoid collisions with a sink or drain pipework. In one embodiment, the panel module 21 is designed in such a way that its geometry and/or cross-section contributes to stiffening the entire frame system 100 with respect to deflection and/or torsion. The panel module 21 can extend over the entire width, defined by the plane 5 of the insertion openings 1a, 2a, of the frame system 100. Furthermore, it can be designed in such a way that it has a rectangular frame with an inserted panel when viewed from the front. This can have the advantage that access to the panel module 21 is possible. This opening option in turn makes it possible to arrange technical devices or functional elements in the panel module 21. These can include, for example, hose guides/hose winders for fittings with pull-out spray or water distribution modules.

For the embodiments with a plinth module 4, for example, no kitchen base unit is required. The plinth module 4 can be supplied as a separate component with the frame system 100. The assembly sequence changes so that the plinth module 4 is arranged between existing kitchen base units first and aligned using leveling screws 11c, 11d, 11e. In one embodiment, spacing from the wall or the neighbouring cabinets can be achieved by means of screw-like elements 9. In a further embodiment, the spacing can also be achieved by means of sheet metal elements formed onto the plinth module.

In order to provide a visually appealing front view of a kitchen unit, cover strips 10a, 10b can be arranged on the sides of the frame system 100, which comprises at least the frame modules 1, 2 and at least the third frame element 3 and which is delivered fully assembled. These cover strips 10a, 10b can be made of the same material as the adjacent carcasses and can, for example, be cut to size directly on site from prefabricated fitting strips.

In one embodiment, two double-sided adhesive tapes can be provided on each side to facilitate the positioning of the fitting strips. The side panels 10a, 10b are fixed in place by means of a screw connection through holes provided in the frame system 100. In one embodiment, the lateral fitting strips can be attached using clip, plug-in or snap-in connections.

It is also conceivable to replace the fitting strips with front panels. These are not arranged on the side of the frame system 100, but are attached to the front of the frame system 100 using plug connectors.

In a further embodiment, the aforementioned front panels can be arranged laterally on the frame system 100 by means of angle pieces. This can have the advantage that the functional components of the frame element 100 are not covered by the front panels.

FIGS. 4 and 5 each show a cross-section in the region of the abutment of a third frame module on a first frame module of a frame system according to an embodiment of the present invention.

FIG. 4 shows a cross-section parallel to a side wall of a frame module 1, 2, more precisely the contact area 18 at which the third frame module 3 rests against the first and second frame modules 1, 2. In FIG. 4, the frame module is designated by the reference sign 1, but this can alternatively or additionally also apply to the second frame module 2. The first frame module 1 has a rebate that is bent inwards, i.e. in the direction of insertion into the insertion opening 1a of the frame module 1. The third frame module 3 has a correspondingly mirror-symmetrical rebate 16a to the upper side 1b of the first frame element 1, which has a vertical upstand 17 in the area facing away from the insertion opening 1a.

In FIG. 5, the first frame module 1 no longer has a rebate. However, the third frame module 3 has a rebate 16c which is bent downwards in the direction of the insertion opening 1a and which is formed in such a way that it partially encompasses or engages a straight edge 19 of the first frame module 1. In this way, the third frame module 3 can be attached to the first frame module 1 by means of a plug-in connection. The same can also be provided for a connection between the first and second frame module 1, 2.

In summary, at least one embodiment of the present invention may provide at least one of the following advantages and/or characteristics:
Flexible adaptation to different kitchen furniture.
Simple, cost-effective production.
Simple, fast and flexible installation of frame modules.
Optimized installation space for modules.
Reliable fixing of the frame modules to each other.
Reliable fixing of the frame system in a piece of work furniture.

Although the present invention was described using preferred embodiments, it is not limited to these, but rather may be modified in various ways.

### LIST OF REFERENCE SIGNS

1 First frame module

1a Insertion opening

1b Top side

1c Underside

1d Side surface

2 Second frame module

2a Insertion opening

2b Top side

2c Underside

2d Side surface

3 Third frame module

3a Base

3b, 3c Leg

4 Fourth frame module

5, 5a Level

6 Direction

7 Tool-free connection

8 Foot

9 Spacer

10a, 10b Cover strip

11a, 11b, 11c, 11d, 11e Screw

12a, 12b Lateral recess for leg

13a, 13b Drawer unit

14 Waste bin

15 Water treatment unit

16a, 16b, 16c Rebate

17 Upstand

18 Contact area

19 Edge

20 Organiser shelf

21 Panel

22 Cross-member

100 Frame system

200 Work furniture

1. A frame system for installation in a piece of work furniture, in particular a piece of sanitary work furniture, comprising
a first frame module and
a second frame module,
wherein the first and second frame modules each have at least one insertion opening for inserting at least one pre-installed functional component for a user,
wherein the respective insertion opening has a quadrangular cross-section, and
wherein the first and second frame modules can be fixed to each other by means of a tool-free connection.

2. The frame system according to claim 1, wherein a third frame module can be fixed to one side of each of the first and second frame modules, the sides of the first and second frame modules forming a common plane.

3. The frame system according to claim 2, wherein the third frame module can be fixed to the first and/or second frame module, in particular to both frame modules, without tools.

4. The frame system according to claim 1, wherein the first frame module and the second frame module have a different cross-section with respect to the respective insertion opening.

5. The frame system according to claims 1, wherein the first and second frame modules are designed in such a way that they can be arranged next to each other in any desired arrangement along a predeterminable direction.

6. The frame system according to claim 1, wherein a fourth frame module is arranged as a base module, wherein the base module can be fixed to one side of each of the first and second frame modules, wherein the sides of the first and second frame modules form a common plane, in particular wherein the plinth module can be arranged on the opposite side of the third frame module on the first and second frame modules.

7. The frame system according to claim 6, wherein the plinth module has a height adjustment device for height and/or level adjustment and/or a distance adjustment device for adjusting a distance to a surrounding element, in particular a wall.

8. The frame system according to claim 1, wherein the tool-free connection is provided in the form of a plug-in connection and/or in the form of a particularly detachable clip and/or snap-in connection.

9. The frame system according to claim 1, wherein at least one cover strip can be arranged on at least one of the frame modules.

10. The frame system according to claim 9, wherein the at least one cover strip can be connected to the at least one frame module in a detachable or non-detachable manner, in particular by means of an adhesive connection.

11. The frame system according to claim 1, wherein one or more fixing elements for fixing the frame modules to one another and/or for fixing at least one cover strip are arranged on at least one of the frame modules.

12. The frame system according to claim 2, wherein the third frame module has a U-shaped cross-section, comprising a base and two lateral legs, wherein the third frame module can be fixed with its base to the first and second frame modules.

13. The frame system according to claim 12, wherein the third frame module has a particularly rectangular recess on the two lateral legs.

14. The frame system according to claim 1, wherein at least one drawer element and/or a waste separation element and/or a water treatment unit can be arranged in one or more of the frame modules.

15. The frame system according to claim 6, wherein the plinth module can be connected to the first and second frame modules by means of a detachable connection, in particular a screw and/or snap-in connection and/or a non-detachable connection, in particular an adhesive connection.

16. The frame system according to claim 2, wherein the third frame module has an edge, in particular an upstand, which is oriented perpendicular to the common plane, in particular wherein this is arranged opposite to a rebate of the first and/or second frame module in the region of the abutment of the third frame module against the first and second frame module.

17. The frame system according to claim 8, wherein the plug-in connection can be provided in the form of a U-shaped rebate on one of the two frame modules, first and second frame module, which can be slid over an edge of the other of the two frame modules.

18. The frame system according to claim 3, wherein the third frame module has a U-shaped rebate which can be slid over an edge of the first and/or second frame module.

19. Work furniture comprising a frame system according to claim 1.

20. The work furniture according to claim 19, wherein a balancing module and/or a storage module can be fixed to the work furniture and/or the frame system.
